(19) United States
(12) Patent Application Publication
(10) Pub. No.: US 2026/0368540 A1
(43) Pub. Date: Nov. 19, 2026

(54) INFORMATION PROCESSING DEVICE, AND LEARNING METHOD

(71) Applicant: NEC Corporation, Tokyo (JP)

(72) Inventors: Akira KITAOKA, Tokyo (JP); Riki ETO, Tokyo (JP)

(73) Assignee: NEC Corporation, Tokyo (JP)

(21) Appl. No.: 19/470,851

(22) PCT Filed: Apr. 11, 2023
(86) PCT No.: PCT/JP2023/014645

§ 371 Date: Sep. 30, 2025

(51) Int. Cl. G06N 3/092

(52) U.S. Cl. CPC G06N 3/092

(57) ABSTRACT

This information processing device (1) for performing inverse reinforcement learning comprises: an acquisition unit (11) that acquires a plurality of solution candidates in a mathematical optimization problem in which a reward function is expressed by a weighted linear sum of feature amounts; an optimal solution determination unit (12) that sets, as a solution to the mathematical optimization problem, a candidate for which the inner product with the weight is maximized, from among the solution candidates; an assessment unit (13) that assesses, on the basis of the determined solution, whether it is necessary to update the weight; and a weight update unit (14) that updates the weight in a case where it is determined that updating is necessary. The information processing apparatus supports decision making processes in inverse reinforcement learning.

### TECHNICAL FIELD

The present disclosure relates to an information processing device or the like that performs inverse reinforcement learning.

### BACKGROUND ART

PTL 1 discloses a technique for deriving a reward function (also referred to as an objective function) by inverse reinforcement learning. Specifically, PTL 1 discloses a learning device that derives a reward function by repeatedly performing processing of estimating a track that minimizes a Wasserstein distance between a probability distribution of a track indicating behavior of a skilled person in each state and a probability distribution of a track determined based on a parameter of the reward function, and updating the parameter of the reward function based on the estimated track.

### CITATION LIST

### Patent Literature

PTL 1: WO 2022/230019 A1

### SUMMARY OF INVENTION

### Technical Problem

The technique of PTL 1 has room for improvement in terms of computation amount. That is, the learning device of PTL 1 performs mathematical optimization at the time of estimating the track, but the computation amount in the mathematical optimization is generally large. In addition, since the track is repeatedly estimated, the computation amount in the entire inverse reinforcement learning also increases in proportion to the number of repetitions.

One aspect of the present disclosure has been made in view of the above problems, and an object thereof is to provide an information processing device and the like capable of reducing a computation amount in an inverse reinforcement learning.

### Solution to Problem

An information processing device according to one aspect of the present disclosure is an information processing device that performs inverse reinforcement learning, the information processing device including an acquisition means for acquiring a plurality of solution candidates in a mathematical optimization problem in which a reward function is represented by a weighted linear sum of feature amounts, an optimal solution determination means for setting, as a solution to the mathematical optimization problem, a candidate having a largest inner product with the weight among the solution candidates, a determination means for determining whether it is necessary to update the weight based on the solution determined by the optimal solution determination means, and a weight update means for updating the weight in a case where the determination means determines that it is necessary to update the weight.

An information processing device according to one aspect of the present disclosure includes an acquisition means for acquiring a plurality of solution candidates in a mathematical optimization problem in which a reward function is represented by a weighted linear sum of feature amounts, and a weight calculation means for calculating, by linear programming, the weight that minimizes a difference between a sum of rewards calculated using a candidate having a largest inner product with the weight among the solution candidates and a sum of rewards calculated using the weight and a state and an action indicated in predetermined track data.

A learning method of inverse reinforcement learning according to one aspect of the present disclosure includes at least one processor to perform acquiring a plurality of solution candidates in a mathematical optimization problem in which a reward function is represented by a weighted linear sum of feature amounts, setting, as a solution to the mathematical optimization problem, a candidate having a largest inner product with the weight among the solution candidates, determining whether it is necessary to update the weight based on the determined solution, and updating the weight in a case where it is determined that it is necessary to update the weight.

A learning method of inverse reinforcement learning according to one aspect of the present disclosure includes at least one processor to perform acquiring a plurality of solution candidates in a mathematical optimization problem in which a reward function is represented by a weighted linear sum of feature amounts, and calculating, by linear programming, the weight that minimizes a difference between a sum of rewards calculated using a candidate having a largest inner product with the weight among the solution candidates and a sum of rewards calculated using the weight and a state and an action indicated in predetermined track data.

A learning program of inverse reinforcement learning according to one aspect of the present disclosure causes a computer to function as an acquisition means for acquiring a plurality of solution candidates in a mathematical optimization problem in which a reward function is represented by a weighted linear sum of feature amounts, an optimal solution determination means for setting, as a solution to the mathematical optimization problem, a candidate having a largest inner product with the weight among the solution candidates, a determination means for determining whether it is necessary to update the weight based on the solution determined by the optimal solution determination means, and a weight update means for updating the weight in a case where the determination means determines that it is necessary to update the weight.

A learning program of inverse reinforcement learning according to one aspect of the present disclosure causes a computer to function as an acquisition means for acquiring a plurality of solution candidates in a mathematical optimization problem in which a reward function is represented by a weighted linear sum of feature amounts, and a weight calculation means for calculating, by linear programming, the weight that minimizes a difference between a sum of rewards calculated using a candidate having a largest inner product with the weight among the solution candidates and a sum of rewards calculated using the weight and a state and an action indicated in predetermined track data.

### Advantageous Effects of Invention

According to one aspect of the present disclosure, an information processing device and the like capable of reducing a computation amount in inverse reinforcement learning can be provided.

### BRIEF DESCRIPTION OF DRAWINGS

FIG. 1 is a block diagram illustrating a configuration of an information processing device according to a first exemplary example embodiment of the present disclosure.

FIG. 2 is a flowchart illustrating a flow of a learning method according to a first exemplary example embodiment of the present disclosure.

FIG. 3 is a block diagram illustrating a configuration of an information processing device according to a first exemplary example embodiment of the present disclosure.

FIG. 4 is a flowchart illustrating a flow of a learning method according to the first exemplary example embodiment of the present disclosure.

FIG. 5 is a block diagram illustrating a configuration of an information processing device according to a second exemplary example embodiment of the present disclosure.

FIG. 6 is a flowchart illustrating a flow of a learning method according to the second exemplary example embodiment of the present disclosure.

FIG. 7 is a block diagram illustrating a configuration of an information processing device according to a third exemplary example embodiment of the present disclosure.

FIG. 8 is a flowchart illustrating a flow of a learning method according to the third exemplary example embodiment of the present disclosure.

FIG. 9 is a block diagram illustrating a configuration of an information processing device according to a fourth exemplary example embodiment of the present disclosure.

FIG. 10 is a flowchart illustrating a flow of a learning method according to the fourth exemplary example embodiment of the present disclosure.

FIG. 11 is a diagram illustrating an example of a computer that executes a command of a program that is software for achieving each function of each device according to each exemplary example embodiment.

### EXAMPLE EMBODIMENT

### First Exemplary Example Embodiment

A first exemplary example embodiment of the present disclosure will be described in detail with reference to the drawings. The present exemplary example embodiment is a basic form of the exemplary example embodiment to be described later.

### (Configuration of Information Processing Device 1)

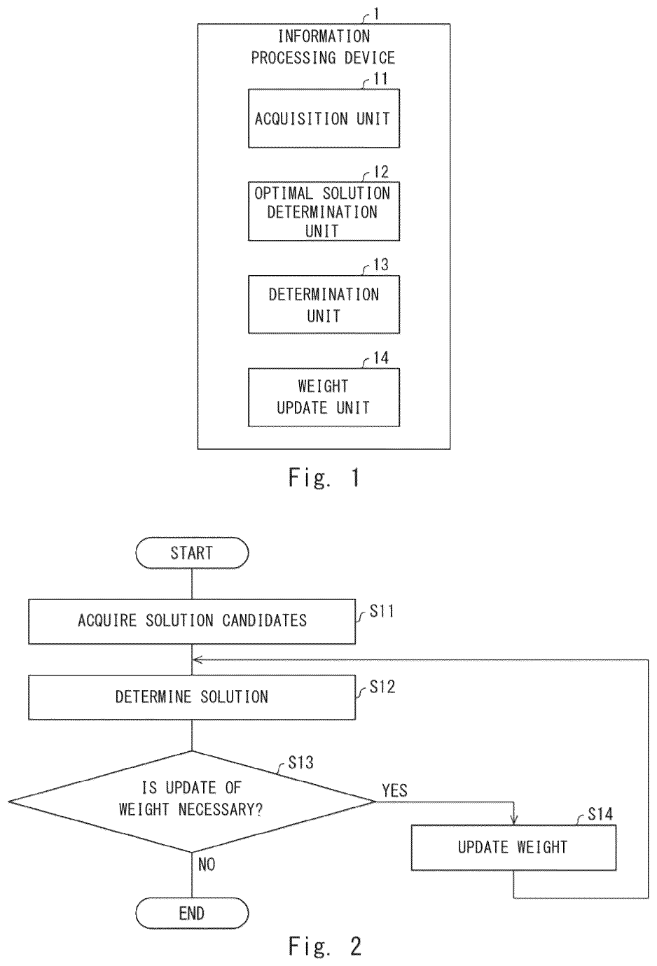

A configuration of an information processing device 1 according to the present exemplary example embodiment will be described with reference to FIG. 1. FIG. 1 is a block diagram illustrating a configuration of the information processing device 1. As illustrated in FIG. 1, the information processing device 1 includes an acquisition unit 11, an optimal solution determination unit 12, a determination unit 13, and a weight update unit 14.

The acquisition unit 11 acquires a plurality of solution candidates in a mathematical optimization problem in which a reward function is represented by a weighted linear sum of feature amounts.

The optimal solution determination unit 12 sets, as a solution to the mathematical optimization problem, a candidate having the largest inner product with the weight among the solution candidates acquired by the acquisition unit 11.

The determination unit 13 determines whether it is necessary to update the weight based on the solution determined by the optimal solution determination unit 12.

The weight update unit 14 updates the weight in a case where the determination unit 13 determines that the update of the weight is necessary.

As described above, the information processing device 1 is an information processing device that performs inverse reinforcement learning, and includes the acquisition unit 11 for acquiring a plurality of solution candidates in a mathematical optimization problem in which a reward function is represented by a weighted linear sum of feature amounts, the optimal solution determination unit 12 for setting, as a solution to the mathematical optimization problem, a candidate having a largest inner product with a weight among the acquired solution candidates, the determination unit 13 for determining whether it is necessary to update the weight based on the solution determined by the optimal solution determination unit 12, and the weight update unit 14 for updating the weight in a case where the determination unit 13 determines that it is necessary to update the weight. According to this configuration, the computation amount in the inverse reinforcement learning can be reduced.

### (Learning Program)

The functions of the information processing device 1 described above can also be achieved by a program. A learning program of inverse reinforcement learning according to the present exemplary example embodiment causes a computer to function as: an acquisition means for acquiring a plurality of solution candidates in a mathematical optimization problem in which a reward function is represented by a weighted linear sum of feature amounts, an optimal solution determination means for setting, as a solution to the mathematical optimization problem, a candidate having a largest inner product with a weight among the acquired solution candidates, a determination means for determining whether it is necessary to update a weight based on a solution determined by the optimal solution determination means, and a weight update means for updating the weight in a case where the determination means determines that it is necessary to update the weight. According to this learning program, the computation amount in the inverse reinforcement learning can be reduced.

### (Flow of Learning Method)

A flow of a learning method of the inverse reinforcement learning according to the present exemplary example embodiment will be described with reference to FIG. 2. FIG. 2 is a flowchart illustrating a flow of a learning method of the inverse reinforcement learning. An executing entity of each step in this learning method may be a processor included in the information processing device 1, may be a processor included in another device, or an executing entity of each step may be a processor provided in each of different devices.

In S11, at least one processor acquires a plurality of solution candidates in a mathematical optimization problem in which a reward function is represented by a weighted linear sum of feature amounts.

In S12, at least one processor sets, as the solution to the mathematical optimization problem, a candidate having the largest inner product with the weight among the solution candidates acquired in S11.

In S13, at least one processor determines whether it is necessary to update the weight based on the solution determined in S12. If NO is determined in S13, the processing is ended.

On the other hand, if YES is determined in S13, the processing proceeds to S14. In S14, at least one processor updates the weight. After the end of S14, the processing returns to S12, a solution is determined based on the updated weight (S12), and whether it is necessary to update the weight is determined (S13). Then, in a case where it is determined that it is necessary to update the weight, the processing proceeds to S14, and the weight is updated again.

As described above, the learning method of the inverse reinforcement learning according to the present exemplary example embodiment includes at least one processor acquiring a plurality of solution candidates in a mathematical optimization problem in which a reward function is represented by a weighted linear sum of feature amounts (S11), setting, as a solution to the mathematical optimization problem, a candidate having a largest inner product with a weight among the acquired solution candidates (S12), determining whether it is necessary to update the weight based on the determined solution (S13), and updating the weight in a case where it is determined that it is necessary to update the weight (S14). According to this learning method, the computation amount in the inverse reinforcement learning can be reduced.

### (Configuration of Information Processing Device 2)

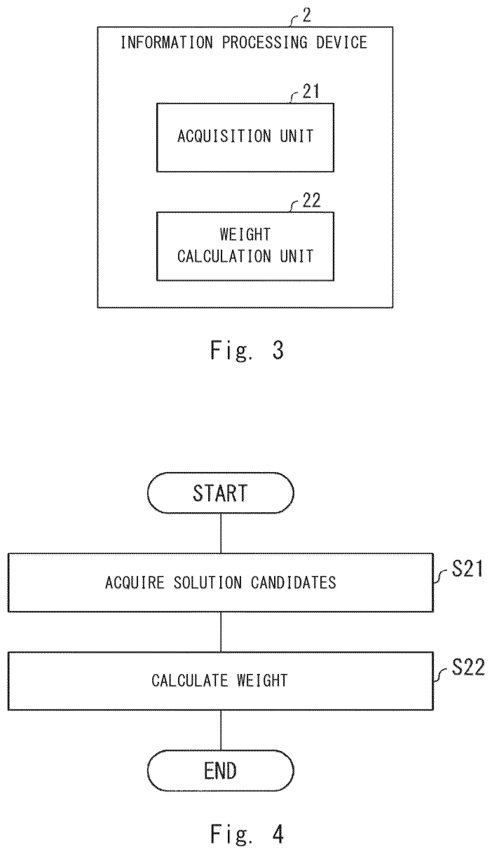

A configuration of the information processing device 2 according to the present exemplary example embodiment will be described with reference to FIG. 3. FIG. 3 is a block diagram illustrating a configuration of the information processing device 2. As illustrated in FIG. 3, the information processing device 2 includes an acquisition unit 21 and a weight calculation unit 22.

The acquisition unit 21 acquires a plurality of solution candidates in a mathematical optimization problem in which a reward function is represented by a weighted linear sum of feature amounts.

The weight calculation unit 22 calculates, by linear programming, a weight that minimizes a difference between a sum of rewards calculated using a candidate having the largest inner product with the weight among solution candidates acquired by the acquisition unit 21 and a sum of rewards calculated using the weight and a state and an action indicated in predetermined track data.

As described above, the information processing device 2 according to the present exemplary example embodiment adopts a configuration including: the acquisition unit 21 for acquiring a plurality of solution candidates in a mathematical optimization problem in which a reward function is represented by a weighted linear sum of feature amounts, and the weight calculation unit 22 for calculating, by linear programming, a weight that minimizes a difference between a sum of rewards calculated using a candidate having the largest inner product with a weight among the solution candidates acquired by the acquisition unit 21 and a sum of rewards calculated using the weight and a state and an action indicated in predetermined track data. According to this configuration, the computation amount in the inverse reinforcement learning can be reduced.

### (Learning Program)

The functions of the information processing device 1 described above can also be achieved by a program. A learning program of inverse reinforcement learning according to the present exemplary example embodiment causes a computer to function as: an acquisition means for acquiring a plurality of solution candidates in a mathematical optimization problem in which a reward function is represented by a weighted linear sum of feature amounts, and the weight calculation means for calculating, by linear programming, a weight that minimizes a difference between a sum of rewards calculated using a candidate having the largest inner product with a weight among the solution candidates acquired by the acquisition means and a sum of rewards calculated using the weight and a state and an action indicated in predetermined track data. According to this program, the computation amount in the inverse reinforcement learning can be reduced.

### (Flow of Learning Method)

A flow of a learning method of the inverse reinforcement learning according to the present exemplary example embodiment will be described with reference to FIG. 4. FIG. 4 is a flowchart illustrating a flow of a learning method of the inverse reinforcement learning. An executing entity of each step in this learning method may be a processor included in the information processing device 2, may be a processor included in another device, or an executing entity of each step may be a processor provided in each of different devices.

In S21, at least one processor acquires a plurality of solution candidates in a mathematical optimization problem in which a reward function is represented by a weighted linear sum of feature amounts.

In S22, at least one processor calculates, by linear programming, a weight that minimizes a difference between a sum of rewards calculated using a candidate having the largest inner product with the weight among the solution candidates acquired in S21 and a sum of rewards calculated using the weight and the state and the action indicated in the predetermined track data.

As described above, the learning method of the inverse reinforcement learning according to the present exemplary example embodiment includes at least one processor acquiring a plurality of solution candidates in a mathematical optimization problem in which a reward function is represented by a weighted linear sum of feature amounts (S21), and calculating, by linear programming, a weight that minimizes a difference between a sum of rewards calculated using a candidate having the largest inner product with a weight among the solution candidates acquired in S21 and a sum of rewards calculated using the weight and a state and an action indicated in predetermined track data (S22). According to this learning method, the computation amount in the inverse reinforcement learning can be reduced.

### Second Exemplary Example Embodiment

### (Configuration of Information Processing Device 1A)

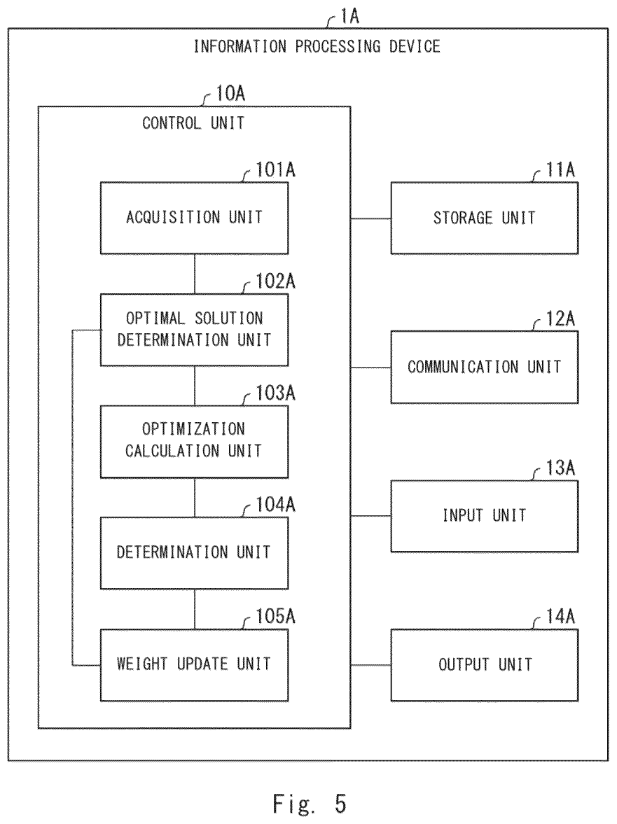

A configuration of an information processing device 1A according to the present exemplary example embodiment will be described with reference to FIG. 5. FIG. 5 is a block diagram illustrating the configuration of the information processing device 1A. The information processing device 1A is a device that performs inverse reinforcement learning.

The inverse reinforcement learning is to learn a weight in a reward function represented by a weighted linear sum of feature amounts. The reward function defines a relationship between a reward and a combination of a state and an action performed in the state, and an action that maximizes the reward can be obtained by using the learned reward function.

As illustrated, the information processing device 1A includes a control unit 10A for integrally controlling units of the information processing device 1A, and a storage unit 11A for storing various types of data to be used by the information processing device 1A. Furthermore, the control unit 10A includes an acquisition unit 101A, an optimal solution determination unit 102A, an optimization calculation unit 103A, a determination unit 104A, and a weight update unit 105A.

The information processing device 1A includes a communication unit 12A for the information processing device 1A to communicate with another device, an input unit 13A for accepting an input to the information processing device 1A, and an output unit 14A for the information processing device 1A to output data. The information processing device 1A may be a device dedicated to inverse reinforcement learning or may be a general-purpose device that can be used for other applications.

The acquisition unit 101A acquires a plurality of solution candidates in a mathematical optimization problem in which a reward function is represented by a weighted linear sum of feature amounts. Furthermore, the optimal solution determination unit 102A determines an optimal solution to the mathematical optimization problem. More specifically, the optimal solution determination unit 102A sets, as a solution to the mathematical optimization problem, a candidate having the largest inner product with the weight being learned among a plurality of solution candidates acquired by the acquisition unit 101A. Details of determination of solution candidates and optimal solutions will be described later.

The optimization calculation unit 103A performs optimization calculation using the solution determined by the optimal solution determination unit 102A. In addition, the determination unit 104A determines whether the end condition of the weight update is satisfied based on the solution determined by the optimal solution determination unit 102A. Then, the weight update unit 105A updates the weight in a case where the determination unit 104A determines that it is necessary to update the weight. Details of the optimization calculation and the weight update method will be described later.

As described above, the information processing device 1A is an information processing device that performs inverse reinforcement learning, and includes the acquisition unit 101A for acquiring a plurality of solution candidates in a mathematical optimization problem in which a reward function is represented by a weighted linear sum of feature amounts, the optimal solution determination unit 102A for setting, as a solution to the mathematical optimization problem, a candidate having a largest inner product with a weight among the acquired solution candidates, the determination unit 104A for determining whether it is necessary to update the weight based on the solution determined by the optimal solution determination unit 102A, and the weight update unit 105A for updating the weight in a case where the determination unit 104A determines that it is necessary to update the weight.

Since the candidate having the largest inner product with the weight of the reward function among the plurality of candidates is a candidate having the largest reward among the plurality of candidates, it is considered to be a candidate having the highest validity as a solution to the mathematical optimization problem. In addition, the operation of searching for the candidate having the largest inner product with the weight from among the plurality of candidates has a smaller computation amount than the operation in general mathematical optimization. Therefore, according to the above configuration, an effect that it becomes possible to reduce the computation amount in the inverse reinforcement learning is obtained.

### (Determination of Solution Candidate and Optimal Solution)

As described above, the optimal solution determination unit 102A sets, as a solution to the mathematical optimization problem, a candidate having the largest inner product with the weight among a plurality of solution candidates in the mathematical optimization problem for calculating the state and the action which the reward calculated by the reward function is maximized. Hereinafter, details of the solution candidates and processing of determining an optimal solution from the solution candidates will be described.

The solution to the mathematical optimization problem is expressed as a(φ, s) using the weight φ, the state s⁽ⁿ⁾, and the action a. Here, n is a label, and n=1, . . . , N. In this case, processing of generating a set A (s⁽ⁿ⁾) (A is A with hat \hat{ }) including a plurality of solution candidates as elements is expressed as follows.

$$[ Mathematical 1 ]$$

$$for n = 1 , … N do$$

$$initialize \hat{A} ( {s}^{( n )} ) = ∅$$

$$for i = 1 , … , I do$$

$$\hat{A} ( {s}^{( n )} ) ← \hat{A} ( {s}^{( n )} ) ⋃ \{ a ( {ϕ}^{( i )} , {s}^{( n )} ) \}$$

A set of a plurality of solution candidates can be generated by such processing. Here, a(φ⁽ⁱ⁾, s⁽ⁿ⁾) in i=1, . . . , I may be generated in advance by using a mathematical optimization method with a relatively small computation amount or the like. For example, it is also possible to generate solution candidates using a known mathematical optimization solver.

Among the above solution candidates, the optimal solution determination unit 102A sets, as a solution to the mathematical optimization problem, a candidate having the largest inner product with the weight. This processing is expressed as follows with the weight to be applied as φ. According to this processing, a solution having the largest inner product with the weight is determined for each of n=1, . . . , and N.

$$[ Mathematical 2 ]$$

$$for n = 1 , … N do$$

$$\hat{a} ( ϕ , {s}^{( n )} ) = arg {max}_{α ∈ \hat{A} ( {s}^{( n )} )} {ϕ}^{T} a$$

$$end for$$

$$return ( \hat{a} ( ϕ , {s}^{( 1 )} ) , … , \hat{a} ( ϕ , {s}^{( N )} ) )$$

### (Optimization Calculation and Weight Update)

A method of the optimization calculation by the optimization calculation unit 103A is not particularly limited, and a method of updating the weight by the weight update unit 105A is also not particularly limited. Then, a method of determining whether it is necessary to update the weight by the determination unit 104A may correspond to a method of optimization calculation by the optimization calculation unit 103A.

For example, the weight update unit 105A may update the weight in such a way that a Wasserstein distance indicating a deviation degree between the probability distribution of the predetermined track data and the probability distribution of the track determined based on the weight of the reward function is minimized. The predetermined track data is data indicating a valid action in each state, and for example, may be called expert data. Hereinafter, an example in which expert data is used as predetermined track data will be described.

In this case, the optimization calculation unit 103A calculates the Wasserstein distance that is a difference between the average value of rewards calculated using the solution determined by the optimal solution determination unit 102A and the weight being learned and the average value of rewards calculated using the weight and the state and the action indicated in the predetermined track data.

Here, the determination unit 104A determines that it is not necessary to update the weight if the calculated Wasserstein distance exceeds a predetermined threshold value, and determines that it is necessary to update the weight if the calculated Wasserstein distance is equal to or less than the predetermined threshold value.

Then, in a case where it is determined that it is necessary to update the weight, the weight update unit 105A updates the weight in such a way that the Wasserstein distance calculated by the optimization calculation unit 103A is minimized. The update may be performed by any method such as, for example, a gradient method.

In this manner, the weight update unit 105A may update the weight in such a way that the Wasserstein distance that is a difference between the average value of rewards calculated using the solution determined by the optimal solution determination unit 102A and the weight being learned and the average value of rewards calculated using the weight and the state and the action indicated in the predetermined track data is minimized.

According to this configuration, since the weight is updated based on the Wasserstein distance, in addition to the effect obtained by the information processing device 1 according to the first exemplary example embodiment, an effect that the weight of the reward function applied to a mathematical optimization problem such as a combination optimization problem in which the distribution of sampling is unknown can be appropriately updated is obtained.

In addition, the optimization calculation unit 103A may calculate the sum of the Wasserstein distance and the entropy regularization term instead of the Wasserstein distance. More specifically, the optimization calculation unit 103A may calculate the sum of the Wasserstein distance and the entropy regularization term by the following Formula (1).

[Mathematical 3]

[symbol]

(φ)=(WASSERSTEIN DISTANCE)+βₜ(ENTROPY REGULARIZATION TERM) (1)

Note that the entropy regularization term is a difference between the feature amount of the track data from which the maximum reward is obtained and the average value of the feature amounts of the track data. Since the value of the entropy regularization term does not become zero, the entropy regularization term is multiplied by the attenuation coefficient βₜ in Formula (1). By setting β=1 at the time the number of updates is t=0 and bringing the value of βₜ closer to 0 as the number of updates t increases, the value of Formula (1) can be converged.

In this case, the determination unit 104A determines that it is necessary to update the weight if the value of Formula (1) exceeds a predetermined threshold value, and determines that it is unnecessary to update the weight if the value is equal to or less than the predetermined threshold value. Then, in a case where it is determined that it is necessary to update the weight, the weight update unit 105A updates the weight φ in such a way that the value of Formula (1) is minimized.

In this manner, the weight update unit 105A may update the weight in such a way that the sum of the Wasserstein distance and the entropy regularization term is minimized. Note that as described above, the Wasserstein distance is the difference between the average value of rewards calculated using the solution determined by the optimal solution determination unit 102A and the weight being learned and the average value of rewards calculated using the weight and the state and the action indicated in the predetermined track data.

According to this configuration, the weight is updated in a direction in which the sum of the Wasserstein distance and the entropy regularization term decreases. Therefore, according to the information processing device 1A according to the present exemplary example embodiment, in addition to the effects obtained by the information processing device 1 according to the first exemplary example embodiment, an effect that the problem of indefiniteness that occurs in a case where there is a plurality of reward functions can be solved can be obtained.

### (Learning Method)

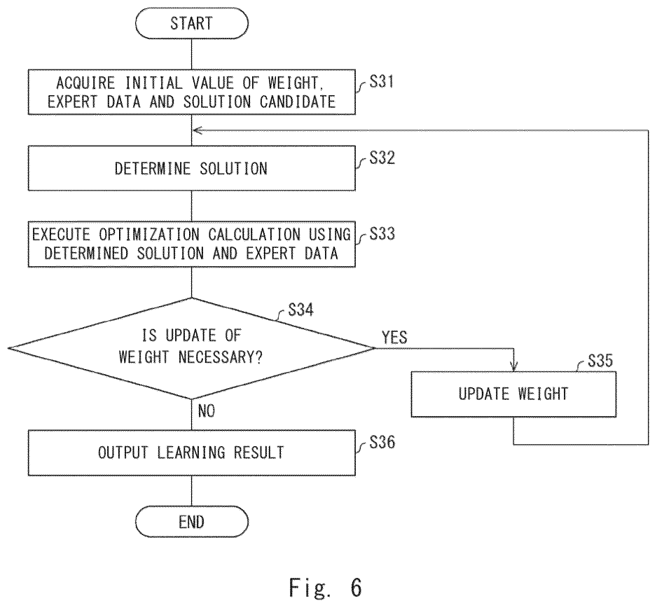

A learning method of inverse reinforcement learning according to the present example embodiment will be described with reference to FIG. 6. FIG. 6 is a flowchart illustrating the flow of the learning method.

In S31, the acquisition unit 101A acquires the initial value of the weight, the expert data, and the solution candidate. Note that, as described above, a plurality of candidate solutions are acquired as solution candidates in a mathematical optimization problem in which a reward function is represented by a weighted linear sum of feature amounts. For example, the acquisition unit 101A acquires each of the above-described data input via the input unit 13A.

In S32, the optimal solution determination unit 102A determines, as the solution to the mathematical optimization problem, a candidate having the largest inner product with the initial value of the weight similarly acquired in S31 among the solution candidates acquired in S31.

In S33, the optimization calculation unit 103A executes optimization calculation using the expert data acquired in S31 and the solution determined in S32.

In S34, the determination unit 104A determines whether it is necessary to update the weight based on the solution determined in S32. For example, the determination unit 104A may determine whether it is necessary to update the weight according to whether the result of the optimization calculation performed in S33 using the solution determined in S32 is equal to or less than a predetermined threshold value. If YES is determined in S34, the processing proceeds to S35, and if NO is determined in S34, the processing proceeds to S36.

In S35, the weight update unit 105A updates the weight based on the solution determined in S32. After the end of S35, the processing returns to S32, a solution is determined based on the updated weight (S32), the optimization calculation is performed using the determined solution (S33), and whether it is necessary to update the weight is determined (S34). Then, in a case where it is determined that it is necessary to update the weight (YES in S34), the processing proceeds to S35, and the weight is updated again.

As described above, in the illustrated learning method, the processing (S32) of setting, as the solution to the mathematical optimization problem, the candidate having the largest inner product with the weight updated by the weight update unit 105A among the solution candidates and the processing (S35) of updating the weight by the weight update unit 105A based on the solution are repeated until a predetermined condition is satisfied.

In S36, the determination unit 104A causes the output unit 14A to output, as a learning result, the value of the weight in a case where it is determined in S34 that it is unnecessary to update the weight, thereby ending the learning method of FIG. 6. Note that, in S36, a reward function to which the weight is applied may be output instead of the weight, or the learning result may be stored in the storage unit 11A or the like without being output, and the processing may be ended.

As described above, the learning method of the inverse reinforcement learning according to the present exemplary example embodiment includes acquiring a plurality of solution candidates in a mathematical optimization problem in which a reward function is represented by a weighted linear sum of feature amounts (S31), setting, as a solution to the mathematical optimization problem, a candidate having a largest inner product with a weight among the acquired solution candidates (S32), determining whether it is necessary to update the weight based on the determined solution (S34), and updating the weight in a case where it is determined that it is necessary to update the weight (S35). Therefore, the computation amount in the inverse reinforcement learning can be reduced.

### Third Exemplary Example Embodiment

### (Configuration of Information Processing Device 1B)

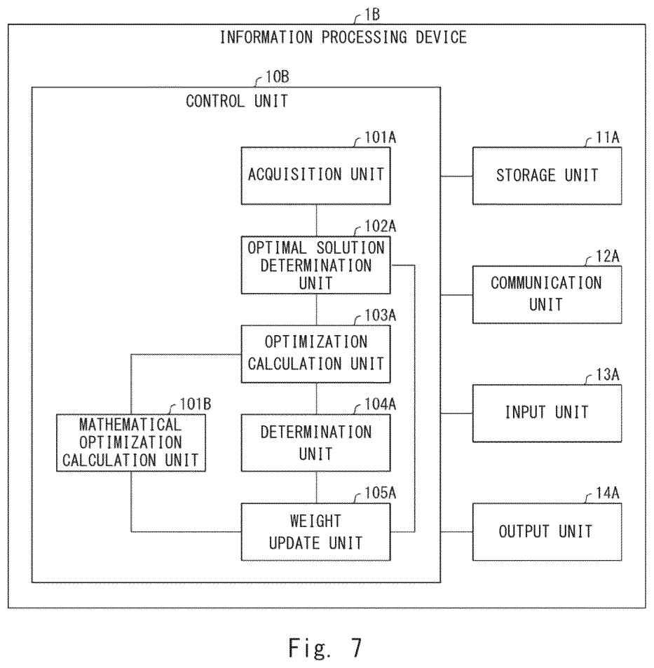

A configuration of an information processing device 1B according to the present exemplary example embodiment will be described with reference to FIG. 7. FIG. 7 is a block diagram illustrating a configuration of the information processing device 1B. Note that components having the same functions as the components described in the second exemplary example embodiment are denoted by the same reference numerals, and the description thereof will not be repeated.

The information processing device 1B is a device that performs inverse reinforcement learning, and includes a control unit 10B for integrally controlling each unit of the information processing device 1B as illustrated in the drawing. Furthermore, the information processing device 1B includes a storage unit 11A, a communication unit 12A, an input unit 13A, and an output unit 14A. In addition, the control unit 10B includes an acquisition unit 101A, an optimal solution determination unit 102A, an optimization calculation unit 103A, a determination unit 104A, a weight update unit 105A, and a mathematical optimization calculation unit 101B. Note that the information processing device 1B may be a device dedicated to inverse reinforcement learning or may be a general-purpose device that can be used for other applications.

The mathematical optimization calculation unit 101B calculates the solution to the mathematical optimization problem by mathematical optimization using the weight in a case where the determination unit 104A determines that it is unnecessary to update based on the solution determined by the optimal solution determination unit 102A. A method of the mathematical optimization calculation is not particularly limited. For example, the mathematical optimization calculation unit 101B may perform mathematical optimization calculation by a known mathematical optimization solver.

In the information processing device 1B, in a case where the mathematical optimization calculation unit 101B calculates the above solution, the determination unit 104A determines whether it is necessary to update the weight based on the calculated solution. Then, the weight update unit 105A updates the weight in a case where the determination unit 104A determines that it is necessary to update the weight.

As described above, the information processing device 1B includes the mathematical optimization calculation unit 101B for calculating the solution to the mathematical optimization problem by mathematical optimization using the weight in a case where the determination unit 104A determines that it is unnecessary to update the weight, where the determination unit 104A determines whether it is necessary to update the weight based on the solution, and the weight update unit 105A updates the weight in a case where the determination unit 104A determines that it is necessary to update the weight.

According to this configuration, a solution is calculated by mathematical optimization. Therefore, according to the information processing device 1B according to the present exemplary example embodiment, in addition to the effects obtained by the information processing device 1 according to the first exemplary example embodiment, an effect that an optimal solution can be calculated with the accuracy of the applied mathematical optimization method and a reward function according to the accuracy can be learned is obtained. In addition, in updating the weight by mathematical optimization, the initial value of the weight can be made close to the optimal value, in such a way that the number of repetitive operations can be reduced, and the computation amount can be reduced as compared with the case of using only mathematical optimization.

### (Learning Method)

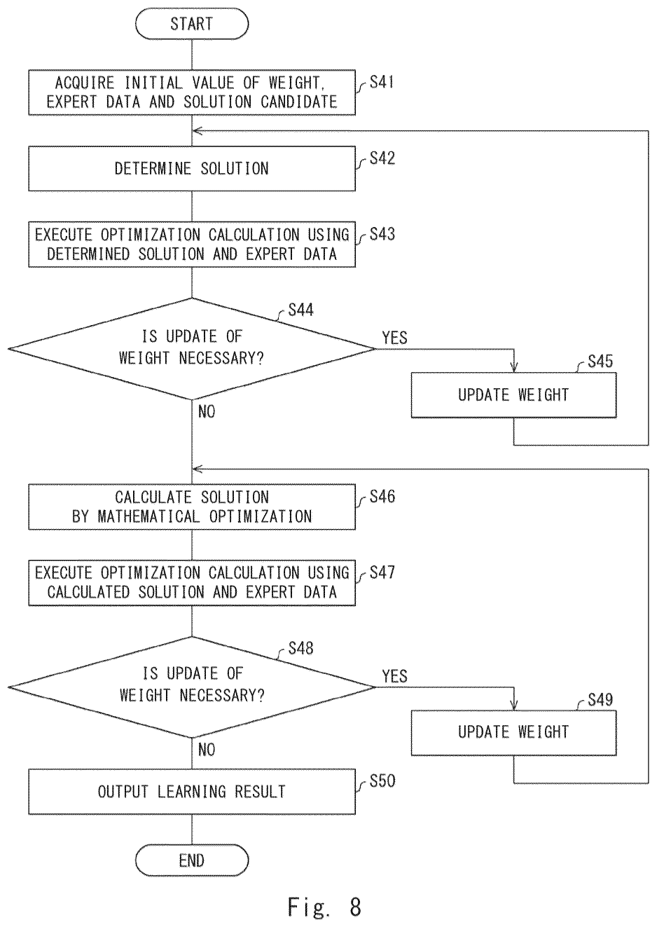

A learning method of inverse reinforcement learning according to the present exemplary example embodiment will be described with reference to FIG. 8. FIG. 8 is a flowchart illustrating the flow of the learning method. Note that the processing of S41 to S45 and S49 is similar to the processing of S31 to S36 in FIG. 6, and thus the description thereof will not be repeated here.

In S46, the mathematical optimization calculation unit 101B calculates a solution to the mathematical optimization problem in which a reward function is represented by a weighted linear sum of feature amounts by mathematical optimization using the weight in a case where it is determined that update is unnecessary in S44.

In S47, similarly to S43 (S33 in FIG. 6), the optimization calculation unit 103A executes optimization calculation using the expert data acquired in S41 and the solution calculated in S46.

In S48, the determination unit 104A determines whether it is necessary to update the weight based on the solution determined in S46. The determination criterion may be the same as or different from that in S44. If NO is determined in S48, the processing proceeds to S50, and if YES is determined in S48, the processing proceeds to S49.

In S49, the weight update unit 105A updates the weight based on the solution calculated in S46. After the end of S49, the processing returns to S46, a solution is calculated based on the updated weight (S46), and after optimization calculation is performed (S47), whether it is necessary to update the weight is determined (S48). Then, in a case where it is determined that it is necessary to update the weight (YES in S48), the processing proceeds to S49, and the weight is updated again.

As described above, in the illustrated learning method, after the update of the weight based on the solution determined by the optimal solution determination unit 102A is ended, that is, after NO is determined in S44, the weight based on the solution calculated by the mathematical optimization calculation unit 101B is updated. In the latter update, a processing (S46) in which the mathematical optimization calculation unit 101B calculates a solution to the mathematical optimization problem and a processing (S49) in which the weight update unit 105A updates the weight based on the solution are repeated until a predetermined condition is satisfied. As a result, the optimal solution can be calculated with the accuracy of the mathematical optimization method applied in S46 and the reward function corresponding to the accuracy can be learned while suppressing the number of repetitive operations in and after S46.

### Fourth Exemplary Example Embodiment

It can be said that the inverse reinforcement learning is to solve the inverse optimization problem illustrated in the following Formula (2). In other words, the inverse reinforcement learning is to obtain the weight φ that minimizes the difference between the reward function of the learner indicated in the first term (i.e., the reward function to obtain) and the reward function of the skilled person (expert) indicated in the second term among the two terms that are the targets of argmin in Formula (2).

$$[ Mathematical 4 ]$$

$${arg min}_{ϕ ∈ Δ} {\sum }_{n = 1}^{N} {max}_{a ∈ \hat{A} ( {s}^{( n )} )} {ϕ}^{T} a - {\sum }_{n = 1}^{N} {ϕ}^{T} {a}^{( n )} \qquad ( 2 )$$

As described in the second exemplary example embodiment, the first term in the Formula (2) can be replaced with a value calculated using a candidate having the largest inner product with the weight of the reward function among a plurality of solution candidates (see “Determination of Solution Candidate and optimal solution” in the second exemplary example embodiment).

Then, by performing the above replacement, the Formula (2) can be rewritten as follows by linear programming. The problem after rewriting can be solved by any method such as an interior method, and for example, can be solved by a solver of linear programming or the like.

$$[ Mathematical 5 ]$$

$$Minimize {\sum }_{n = 1}^{N} {t}_{n} ,$$

$$Subject to \{ \begin{matrix}ϕ ∈ Δ := \{ ϕ \vert ϕ \geq 0 , {1}^{T} ϕ = 1 \} , \\ ∀ n , ∀ a ∈ \hat{A} ( {s}^{( n )} ) , {ϕ}^{T} ( a - {a}^{( n )} ) \leq {t}_{n} .\end{matrix}$$

The information processing device 2A according to the present exemplary example embodiment calculates the weight of the reward function by solving the linear programming problem obtained by the above rewriting. As a result, an appropriate weight can be calculated without repeatedly performing mathematical optimization having a large computation amount. That is, according to the information processing device 2A, an effect that the computation amount in the inverse reinforcement learning can be reduced is obtained.

### (Configuration of Information Processing Device 2A)

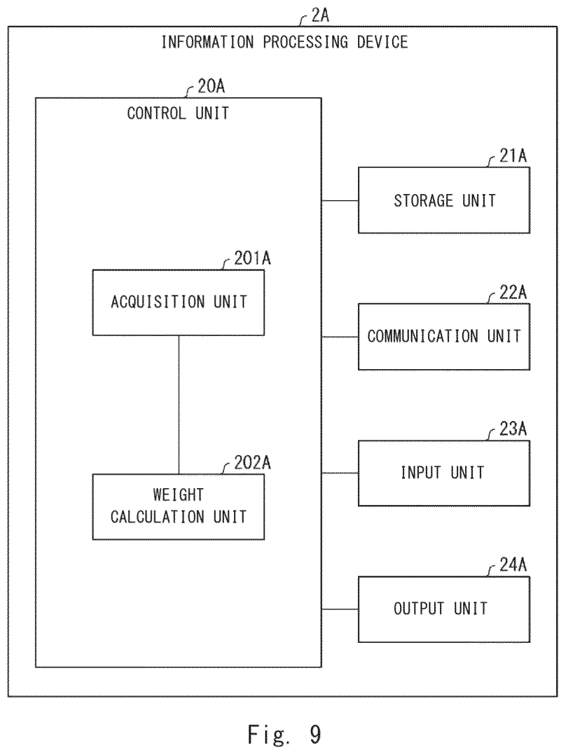

A configuration of an information processing device 2A according to the present exemplary example embodiment will be described with reference to FIG. 9. FIG. 9 is a block diagram illustrating the configuration of the information processing device 2A. The information processing device 2A is a device that performs inverse reinforcement learning, and as illustrated in the drawing, includes a control unit 20A for integrally controlling each unit of the information processing device 2A, and a storage unit 21A that is a storage device for storing various data used by the information processing device 2A. Furthermore, the control unit 20A includes an acquisition unit 201A and a weight calculation unit 202A.

The information processing device 2A includes a communication unit 22A for the information processing device 2A to communicate with another device, an input unit 23A for accepting an input to the information processing device 2A, and an output unit 24A for the information processing device 2A to output data. Note that the information processing device 2A may be a device dedicated to inverse reinforcement learning or may be a general-purpose device that can be used for other applications.

Similarly to the acquisition unit 101A of the second exemplary example embodiment, the acquisition unit 201A acquires a plurality of solution candidates in a mathematical optimization problem in which a reward function is represented by a weighted linear sum of feature amounts.

The weight calculation unit 202A calculates, by linear programming, a weight that minimizes a difference between a sum of rewards calculated using a candidate having the largest inner product with the weight among solution candidates acquired by the acquisition unit 201A and a sum of rewards calculated using the weight and a state and an action indicated in predetermined track data. Specifically, the weight calculation unit 202A calculates the weight by solving the above-described linear programming problem obtained by rewriting Formula (2) by linear programming. Furthermore, the weight calculation unit 202A can also obtain an optimized action by solving the linear programming problem.

As described above, the information processing device 2A includes the acquisition unit 201A for acquiring a plurality of solution candidates in a mathematical optimization problem in which a reward function is represented by a weighted linear sum of feature amounts, and the weight calculation unit 202A for calculating, by linear programming, a weight that minimizes a difference between a sum of rewards calculated using a candidate having the largest inner product with a weight among the solution candidates acquired by the acquisition unit 201A and a sum of rewards calculated using the weight and a state and an action indicated in predetermined track data.

According to this configuration, an appropriate weight can be calculated without repeatedly performing mathematical optimization having a large computation amount. Therefore, according to the information processing device 2A, an effect that the computation amount in the inverse reinforcement learning can be reduced is obtained. Note that an example of using expert data as predetermined track data, similarly to the second exemplary example embodiment, will be described below.

### (Learning Method)

A learning method of inverse reinforcement learning according to the present exemplary example embodiment will be described with reference to FIG. 10. FIG. 10 is a flowchart illustrating the flow of the learning method.

In S61, the acquisition unit 201A acquires a solution candidate in a mathematical optimization problem in which expert data and a reward function are represented by a weighted linear sum of feature amounts. Note that a plurality of solution candidates is acquired. For example, the acquisition unit 201A acquires each of the above-described data input via the input unit 23A.

In S62, the weight calculation unit 202A calculates, by linear programming, a weight that minimizes a difference between the sum of rewards calculated using the candidate having the largest inner product with the weight among the solution candidates acquired in S61 and the sum of rewards calculated using the weight and the state and action indicated in the predetermined track data. In S62, as described at the beginning of the present exemplary example embodiment, the weight is calculated by solving the linear programming problem obtained by rewriting Formula (2) by linear programming.

In S63, the weight calculation unit 202A causes the output unit 24A to output the value of the weight calculated in S62 as a learning result, whereby the learning method in FIG. 10 is ended. Note that, in S63, a reward function to which the weight is applied may be output instead of the weight, or the learning result may be stored in the storage unit 21A or the like without being output, and the processing may be ended.

### (Update of Weight by Mathematical Optimization)

The information processing device 2A may include the mathematical optimization calculation unit 101B, the optimization calculation unit 103A, the determination unit 104A, and the weight update unit 105A illustrated in the third exemplary example embodiment. The learning method in this case has a flow in which the processing of S46 to S50 of FIG. 8 is performed after the processing of S61 and S62 of FIG. 10.

More specifically, in S61, the acquisition unit 201A acquires expert data and a plurality of solution candidates, and in S62, the weight calculation unit 202A calculates the weight by linear programming. Subsequently, in S46, the mathematical optimization calculation unit 101B calculates a solution to the mathematical optimization problem by mathematical optimization using the weight calculated by the weight calculation unit 202A.

Next, in S47, the optimization calculation unit 103A executes optimization calculation using the solution calculated by the mathematical optimization calculation unit 101B and the expert data acquired in S61. Then, in S48, the determination unit 104A determines whether it is necessary to update the weight based on the solution calculated in S46 (specifically, using the result of the optimization calculation in S47). Then, in a case where the determination unit 104A determines that it is necessary to update the weight (YES in S48), the processing proceeds to S49, and the weight update unit 105A updates the weight. The processing of S46 to S49 is repeated until NO is determined in S48.

As described above, the information processing device 2A may include the mathematical optimization calculation unit 101B for calculating a solution to a mathematical optimization problem by mathematical optimization using the weight calculated by the weight calculation unit 202A, the determination unit 104A for determining whether it is necessary to update the weight based on the solution calculated by the mathematical optimization calculation unit 101B, and the weight update unit 105A for updating the weight in a case where the determination unit 104A determines that it is necessary to update the weight.

As a result, an effect that the optimal solution can be calculated with the accuracy of the applied mathematical optimization method and the reward function corresponding to the accuracy can be learned while suppressing the number of repetitive operations including calculating the solution by the mathematical optimization is obtained.

### MODIFIED EXAMPLES

An executing entity of each processing described in the above-described exemplary example embodiments is optional, and is not limited to the above-described examples. For example, a learning system having functions similar to those of the information processing devices 1A, 1B, and 2A can be constructed by a plurality of devices capable of communicating with each other. Furthermore, an executing entity of each processing illustrated in the flowcharts of FIGS. 6, 8, and 10 may be one device (also referred to as a processor) or a plurality of devices (also referred to as processors).

### [Example of Implementation by Software]

Some or all of the functions of the information processing devices 1A, 1B, and 2A may be implemented by hardware such as an integrated circuit (IC chip) or may be implemented by software.

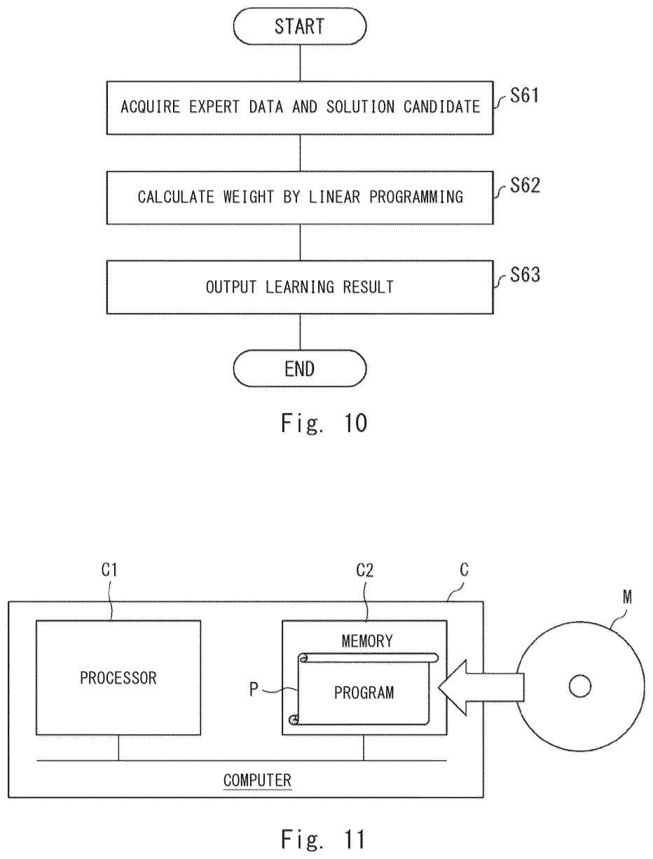

In the latter case, the information processing devices 1A, 1B and 2A are implemented, for example, by a computer that executes a command of a program that is software for achieving each function. An example of such a computer (hereinafter, referred to as a computer C) is illustrated in FIG. 11. The computer C includes at least one processor C1 and at least one memory C2. A program P (learning program) for causing the computer C to operate as the information processing devices 1A, 1B, and 2A is recorded in the memory C2. In the computer C, the processor C1 achieves each function of the information processing devices 1A, 1B and 2A by reading the program P from the memory C2 and executing the program P.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof can be used. As the memory C2, for example, a flash memory, a Hard Disk Drive (HDD), a Solid State Drive (SSD), or a combination thereof can be used.

The computer C may further include a Random Access Memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### [Supplementary Matter 1]

The present disclosure is not limited to the above-described example embodiments, and various changes can be made without departing from the spirit and the scope as defined by the claims. For example, example embodiments obtained by appropriately combining the technical means disclosed in the above-described example embodiments are also included in the technical scope of the present disclosure.

### [Supplementary Matter 2]

Some or all the above-described example embodiments may be described as follows. However, the present disclosure is not limited to the following aspects.

### (Supplementary Note 1)

An information processing device that performs inverse reinforcement learning, the information processing device including:
an acquisition means for acquiring a plurality of solution candidates in a mathematical optimization problem in which a reward function is represented by a weighted linear sum of feature amounts, an optimal solution determination means for setting, as a solution to the mathematical optimization problem, a candidate having a largest inner product with the weight among the solution candidates, a determination means for determining whether it is necessary to update the weight based on the solution determined by the optimal solution determination means, and a weight update means for updating the weight in a case where the determination means determines that it is necessary to update the weight.

### (Supplementary Note 2)

The information processing device according to supplementary note 1, in which the weight update means updates the weight in such a way as to minimize a Wasserstein distance that is a difference between an average value of rewards calculated using the solution determined by the optimal solution determination means and the weight and an average value of rewards calculated using the weight and a state and an action indicated in predetermined track data.

### (Supplementary Note 3)

The information processing device according to supplementary note 1, wherein the weight update means updates the weight in such a way as to minimize a sum of a Wasserstein distance, which is a difference between an average value of rewards calculated using the solution determined by the optimal solution determination means and the weight and an average value of rewards calculated using the weight and a state and an action indicated in predetermined track data, and an entropy regularization term.

### (Supplementary Note 4)

The information processing device according to any one of supplementary notes 1 to 3, further including a mathematical optimization calculation means for calculating a solution to the mathematical optimization problem by mathematical optimization using the weight in a case where the determination means determines that update is unnecessary, in which the determination means determines whether it is necessary to update the weight based on the solution calculated by the mathematical optimization calculation means, and the weight update means updates the weight in a case where the determination means determines that it is necessary to update the weight.

### (Supplementary Note 5)

An information processing device including: an acquisition means for acquiring a plurality of solution candidates in a mathematical optimization problem in which a reward function is represented by a weighted linear sum of feature amounts, and a weight calculation means for calculating, by linear programming, the weight that minimizes a difference between a sum of rewards calculated using a candidate having a largest inner product with the weight among the solution candidates and a sum of rewards calculated using the weight and a state and an action indicated in predetermined track data.

### (Supplementary Note 6)

The information processing device according to supplementary note 5, further including: a mathematical optimization calculation means for calculating a solution to the mathematical optimization problem by mathematical optimization using the weight calculated by the weight calculation means, a determination means for determining whether it is necessary to update the weight based on the solution calculated by the mathematical optimization calculation means; and a weight update means for updating the weight in a case where the determination means determines that it is necessary to update the weight.

### (Supplementary Note 7)

A learning method of inverse reinforcement learning, the learning method including at least one processor to perform acquiring a plurality of solution candidates in a mathematical optimization problem in which a reward function is represented by a weighted linear sum of feature amounts, setting, as a solution to the mathematical optimization problem, a candidate having a largest inner product with the weight among the solution candidates, determining whether it is necessary to update the weight based on the determined solution, and updating the weight in a case where it is determined that it is necessary to update the weight.

### (Supplementary Note 8)

A learning method of inverse reinforcement learning, the learning method including at least one processor to perform acquiring a plurality of solution candidates in a mathematical optimization problem in which a reward function is represented by a weighted linear sum of feature amounts, and calculating, by linear programming, the weight that minimizes a difference between a sum of rewards calculated using a candidate having a largest inner product with the weight among the solution candidates and a sum of rewards calculated using the weight and a state and an action indicated in predetermined track data.

### (Supplementary Note 9)

A learning program of inverse reinforcement learning for causing a computer to function as: an acquisition means for acquiring a plurality of solution candidates in a mathematical optimization problem in which a reward function is represented by a weighted linear sum of feature amounts, an optimal solution determination means for setting, as a solution to the mathematical optimization problem, a candidate having a largest inner product with the weight among the solution candidates, a determination means for determining whether it is necessary to update the weight based on the solution determined by the optimal solution determination means, and a weight update means for updating the weight in a case where the determination means determines that it is necessary to update the weight.

### (Supplementary Note 10)

A learning program of inverse reinforcement learning for causing a computer to function as: an acquisition means for acquiring a plurality of solution candidates in a mathematical optimization problem in which a reward function is represented by a weighted linear sum of feature amounts, and a weight calculation means for calculating, by linear programming, the weight that minimizes a difference between a sum of rewards calculated using a candidate having a largest inner product with the weight among the solution candidates and a sum of rewards calculated using the weight and a state and an action indicated in predetermined track data.

### [Supplementary Matter 3]

### (Supplementary Note 1)

Some or all the above-described example embodiments may be further described as follows.

An information processing device including at least one processor, in which the processor executes: acquisition processing of acquiring a plurality of solution candidates in a mathematical optimization problem in which a reward function is represented by a weighted linear sum of feature amounts, optimal solution determination processing of setting, as a solution to the mathematical optimization problem, a candidate having a largest inner product with the weight among the solution candidates, determination processing of determining whether it is necessary to update the weight based on the solution determined by an optimal solution determination means, and weight update processing of updating the weight in a case where a determination means determines that it is necessary to update the weight.

Note that the information processing device may further include a memory, and the memory may store a program for causing the processor to execute the acquisition processing, the optimal solution determination processing, the determination processing, and the update processing. This program may be recorded in a non-transitory tangible computer-readable recording medium.

### (Supplementary Note 2)

Some or all of the above-described example embodiments can be further expressed as follows.

An information processing device including at least one processor, in which the processor executes acquisition processing of acquiring a plurality of solution candidates in a mathematical optimization problem in which a reward function is represented by a weighted linear sum of feature amounts, and weight calculation processing of calculating, by linear programming, a weight that minimizes a difference between a sum of rewards calculated using a candidate having a maximum inner product with the weight among the solution candidates and a sum of rewards calculated using the weight and a state and an action indicated in predetermined track data.

Note that the information processing device may further include a memory, and the memory may store a program for causing the processor to execute the acquisition processing and the weight calculation processing. This program may be recorded in a non-transitory tangible computer-readable recording medium.

### REFERENCE SIGNS LIST

1 information processing device
11 acquisition unit
12 optimal solution determination unit
13 determination unit
14 weight update unit
2 information processing device
21 acquisition unit
22 weight calculation unit
1A information processing device
101A acquisition unit
102A optimal solution determination unit
104A determination unit
105A weight update unit
1B information processing device
101A acquisition unit
102A optimal solution determination unit
104A determination unit
105A weight update unit
101B mathematical optimization calculation unit
2A information processing device
201A acquisition unit
202A weight calculation unit

What is claimed is:

1. An information processing device that performs inverse reinforcement learning, the information processing device comprising:
an acquirer for acquiring a plurality of solution candidates in a mathematical optimization problem in which a reward function is represented by a weighted linear sum of feature amounts;
an optimal solution determinator for setting, as a solution to the mathematical optimization problem, a candidate having a largest inner product with the weight among the solution candidates;
a determinator for determining whether it is necessary to update the weight based on the solution determined by the optimal solution determinator; and
a weight updater for updating the weight in a case where the determinator determines that it is necessary to update the weight.

2. The information processing device according to claim 1, wherein the weight updater updates the weight in such a way as to minimize a Wasserstein distance that is a difference between an average value of rewards calculated using the solution determined by the optimal solution determinator and the weight and an average value of rewards calculated using the weight and a state and an action indicated in predetermined track data.

3. The information processing device according to claim 1, wherein the weight updater updates the weight in such a way as to minimize a sum of a Wasserstein distance, which is a difference between an average value of rewards calculated using the solution determined by the optimal solution determinator and the weight and an average value of rewards calculated using the weight and a state and an action indicated in predetermined track data, and an entropy regularization term.

4. The information processing device according to claim 1, further comprising a mathematical optimization calculator for calculating a solution to the mathematical optimization problem by mathematical optimization using the weight in a case where the determinator determines that update is unnecessary, wherein
the determinator determines whether it is necessary to update the weight based on the solution calculated by the mathematical optimization calculator, and
the weight updater updates the weight in a case where the determinator determines that it is necessary to update the weight.

5. An information processing device comprising:
an acquirer for acquiring a plurality of solution candidates in a mathematical optimization problem in which a reward function is represented by a weighted linear sum of feature amounts; and
a weight calculator for calculating, by linear programming, the weight that minimizes a difference between a sum of rewards calculated using a candidate having a largest inner product with the weight among the solution candidates and a sum of rewards calculated using the weight and a state and an action indicated in predetermined track data.

6. The information processing device according to claim 5, further comprising:
a mathematical optimization calculator for calculating a solution to the mathematical optimization problem by mathematical optimization using the weight calculated by the weight calculator;
a determinator for determining whether it is necessary to update the weight based on the solution calculated by the mathematical optimization calculator; and
a weight updater for updating the weight in a case where the determinator determines that it is necessary to update the weight.

7. A learning method of inverse reinforcement learning, the learning method comprising at least one processor to perform:
acquiring a plurality of solution candidates in a mathematical optimization problem in which a reward function is represented by a weighted linear sum of feature amounts;
setting, as a solution to the mathematical optimization problem, a candidate having a largest inner product with the weight among the solution candidates;
determining whether it is necessary to update the weight based on the determined solution; and
updating the weight in a case where it is determined that it is necessary to update the weight.

8-10. (canceled)
